(19) United States
(12) Patent Application Publication
(10) Pub. No.: US 2005/0213795 A1
(43) Pub. Date: Sep. 29, 2005

(54) Sensor unit and print state inspection apparatus using the same

(76) Inventor: Mamoru Sawamura, Higashioumi-city (JP)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 11/091,312

(22) Filed: Mar. 28, 2005

(30) Foreign Application Priority Data
Mar. 29, 2004 (JP) 2004-94316

(51) Int. Cl. G06K 9/00

(52) U.S. Cl. 382/112

(57) ABSTRACT

A sensor unit according to the present invention is a sensor unit that irradiates a print surface with light and picks up an image formed by reflected light from the print surface and includes: an image pickup portion including an image pickup element and a lens fitted to the image pickup element; an illumination portion including a light-emission element and a lens fitted to the light-emission element; and a reflecting portion including at least one mirror that reflects the reflected light from the print surface in a direction having a predetermined angle with respect to the direction of the normal to the print surface. According to the present invention, a sensor unit, which is highly accurate and whose miniaturization is possible, and a print state inspection apparatus using the sensor unit are provided.

### BACKGROUND OF THE INVENTION

1. Field of the Invention

The present invention relates to a sensor unit and a print state inspection apparatus using the sensor unit. More specifically, the present invention relates to a sensor unit, which is highly accurate and whose miniaturization is possible, and a print state inspection apparatus using the sensor unit.

2. Description of the Related Art

Conventionally, a print state inspection apparatus has been widely known which irradiates a print surface with light, picks up an image formed by reflected light from the print surface, and detects a print defect with reference to the obtained image.

FIG. 7 is a schematic construction diagram of an example of a conventional print state inspection apparatus. A print state inspection apparatus 700 shown in FIG. 7 is an inspection apparatus of so-called in-line type and continuously inspects print surfaces of prints transported. To do so, the apparatus 700 includes a sensor portion 710 and a print transport portion 720. The sensor portion 710 includes an image pickup element 71 and an illumination means 72. The illumination means 72 irradiates a print surface of a print W supplied to the transport portion with light, the image pickup element 71 captures an image formed by reflected light from the print surface, and a detection portion (not shown) detects a print defect by analyzing image data of the image.

The image pickup element 71 is preferably a CCD camera because it is possible to achieve high accuracy with the CCD camera. In the construction shown in FIG. 7, however, when it is attempted to pick up an image of the print surface in its entirety using the CCD camera, a distance between the CCD camera 71 and the print W becomes very long (ordinarily, a distance of 800 mm or more is required). Therefore, it is required to incorporate the sensor portion 710 into a print apparatus from an early stage of manufacture, which makes it impossible to commercialize the sensor portion alone. Also, when it is desired to improve the inspection accuracy of the print apparatus, it is required to modify or change an inspection apparatus incorporated into the print apparatus, which is very disadvantageous in terms of economy. Among inspection apparatuses using photosensors of low accuracy, there is an inspection apparatus whose sensor portion (sensor unit) is detachable (see JP 2002-333404 A, for instance). However, the miniaturization and detachable construction of a sensor unit of an inspection apparatus using a highly accurate CCD camera are not yet realized.

As described above, a sensor unit, which is highly accurate and whose miniaturization is possible, and a print state inspection apparatus using the sensor unit are strongly desired.

### SUMMARY OF THE INVENTION

The present invention has been made in order to solve the above-mentioned problems with the prior art, and has an object to provide a sensor unit, which is highly accurate and whose miniaturization is possible, and a print state inspection apparatus using the sensor unit.

A sensor unit according to an embodiment of the present invention irradiates a print surface with light and picks up an image formed by reflected light from the print surface. The sensor unit comprises: an image pickup portion including an image pickup element and a lens fitted to the image pickup element; an illumination portion including a light-emission element and a lens fitted to the light-emission element; and a reflecting portion including at least one mirror that reflects the reflected light from the print surface in a direction having a predetermined angle with respect to a direction of normal to the print surface.

In one embodiment of the invention, the reflecting portion includes: a first mirror that reflects the reflected light from the print surface in a first direction having a predetermined angle with respect to the direction of the normal to the print surface; and a second mirror that reflects the light reflected in the first direction in a second direction having a predetermined angle with respect to the first direction.

In another embodiment of the invention, the first direction has an angle of 90 degrees with respect to the direction of the normal to the print surface, and wherein the second direction has an angle of 90 degrees with respect to the first direction.

Instill another embodiment of the invention, the image pickup element is a CCD camera, and wherein the light-emission element is a high-intensity LED.

In still another embodiment of the invention, the first mirror and the second mirror are each an evaporated mirror.

According to another aspect of the present invention, a print state inspection apparatus is provided. The print state inspection apparatus irradiates a print surface of a print arranged at a predetermined position with light, picks up an image formed by reflected light from the print surface, and detects a print defect with reference to an obtained image. The print state inspection apparatus comprises: a sensor portion that irradiates the print surface with the light and picks up the image formed by the reflected light from the print surface; and a detection portion that detects the print defect by analyzing image data obtained by the sensor portion, wherein the sensor portion includes: an image pickup portion including an image pickup element and a lens fitted to the image pickup element; an illumination portion including a light-emission element and a lens fitted to the light-emission element; and a reflecting portion including at least one mirror that reflects the reflected light from the print surface in a direction having a predetermined angle with respect to a direction of normal to the print surface.

According to the present invention, a specific light-emission element is combined with an optical system as an illumination portion, and a reflecting portion that uses a specific mirror is provided. As a result, it is possible to provide a sensor unit, which is highly accurate and whose miniaturization is possible, and a print state inspection apparatus using the sensor unit. As a matter of fact, according to the sensor unit of the present invention, it is possible to reduce the height of the unit to around 220 mm. In addition, it is possible to set a working distance (distance between a sensor lower end (in the vicinity of an illumination portion) and a print) at around 35 to 40 mm. Consequently, it is possible to set a distance between the CCD camera and the print at around only 250 mm, which is ¼ or less of a distance in the case of the conventional CCD sensor.

### BRIEF DESCRIPTION OF THE DRAWINGS

In the accompanying drawings:

FIG. 1 is a schematic construction diagram of a sensor unit according to a preferred embodiment of the present invention;

FIG. 2 is a schematic perspective view illustrating an entire external appearance of the sensor unit shown in FIG. 1;

FIG. 3 is a see-through schematic perspective view illustrating a state of an image pickup portion in the sensor unit;

FIG. 4 is a schematic construction diagram of a sensor unit according to another preferred embodiment of the present invention;

FIG. 5 is a block diagram showing a construction of a print state inspection apparatus according to a preferred embodiment of the present invention;

FIG. 6 is a schematic perspective view of an operation stand that is applicable to the print state inspection apparatus according to the present invention; and

FIG. 7 is a schematic construction diagram of an example of a conventional print state inspection apparatus.

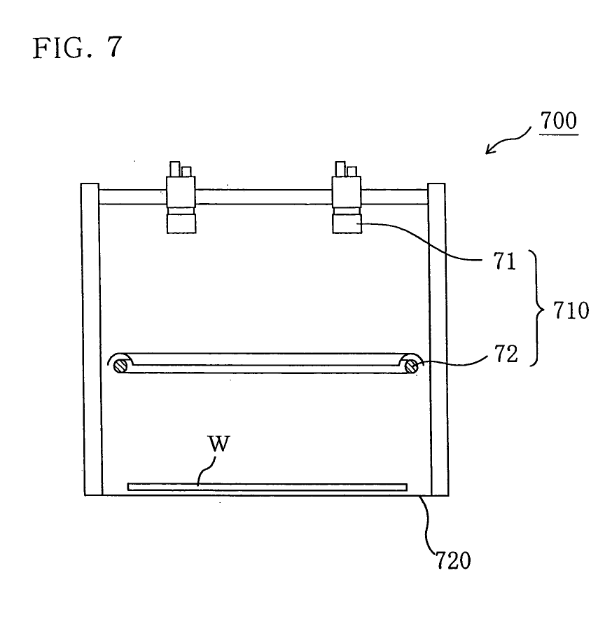

### DETAILED DESCRIPTION OF THE PREFERRED EMBODIMENTS

Preferred embodiments of the present invention will now be described with reference to the accompanying drawings, although there is no intention to limit the present invention to the embodiments.

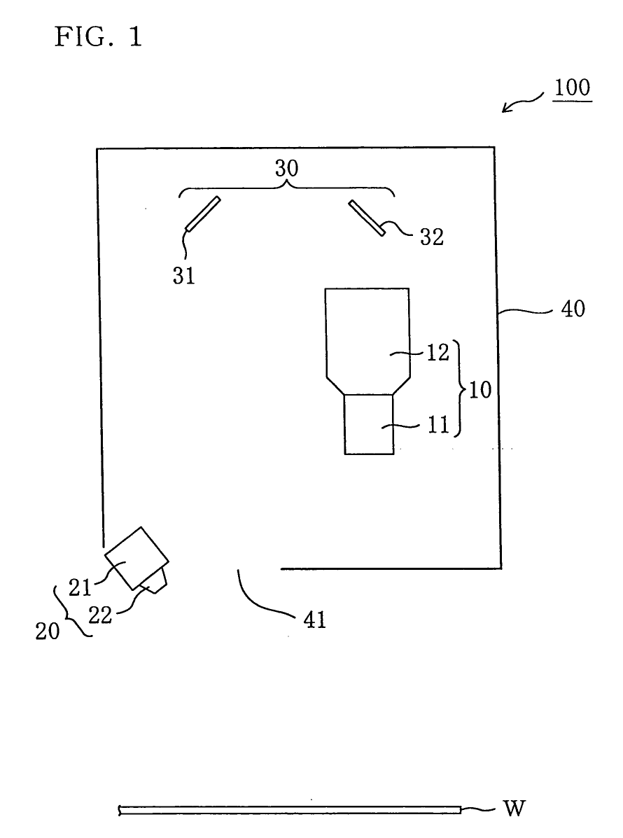

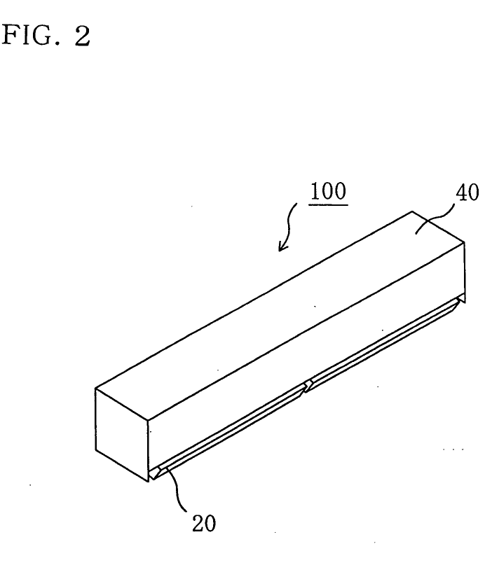

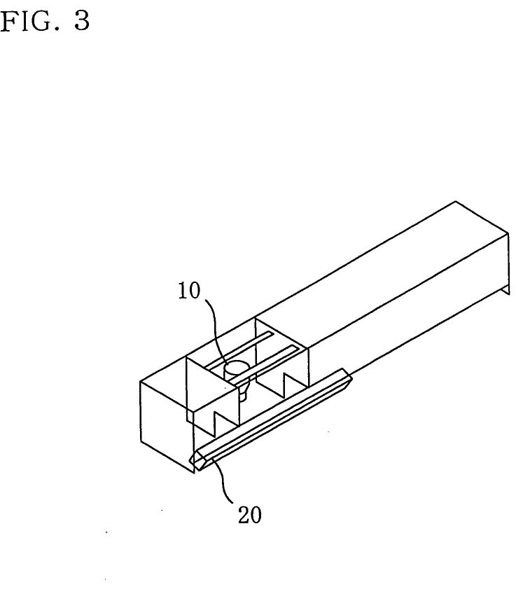

FIG. 1 is a schematic construction diagram of a sensor unit according to a preferred embodiment of the present invention, FIG. 2 is a schematic perspective view illustrating an entire external appearance of the sensor unit shown in FIG. 1, and FIG. 3 is a see-through schematic perspective view illustrating a state of an image pickup portion in the sensor unit. A sensor unit 100 is a unit that irradiates a print surface of a print W with light and picks up an image formed by reflected light from the print surface. To do so, the sensor unit 100 includes an image pickup portion 10, an illumination portion 20, and a reflecting portion 30. The image pickup portion 10 includes an image pickup element 11 and a lens 12 fitted to the image pickup element 11. Also, the illumination portion 20 includes a light-emission element 21 and a lens 22 fitted to the light-emission element 21. Further, the reflecting portion 30 includes a first mirror 31 that reflects the reflected light from the print surface of the print W in a first direction D1 having a predetermined angle with respect to the direction of the normal to the print surface and a second mirror 32 that further reflects the light reflected in the first direction D1 in a second direction D2 having a predetermined angle with respect to the first direction. As shown in FIGS. 1 to 3, the image pickup portion 10 and the reflecting portion 30 are accommodated in a block-shaped housing 40 having an opening (portion through which the reflected light is introduced into the housing 40) 41 that extends in a lengthwise direction. The illumination portion 20 is fitted to an arbitrary appropriate portion of the housing 40 with an arbitrary appropriate means so as to illuminate the print surface of the print W in its entirety as appropriate.

More specifically, the image pickup portion 10 is fitted in the housing 40 so that the image pickup element 11 and the lens 12 are directed in the same direction as the print surface (upward direction, in ordinary cases). The image pickup element 11 is preferably a CCD camera. By using the CCD camera, detection of a color print at high resolution becomes possible. The lens 12 preferably has a wide angel and a short focal distance. A specifically preferable angle of view of the lens 12 is around 95 to 110 degrees and a specifically preferable focal distance thereof is around 12 to 20 mm. By using such a lens having a wide angle and a short focal distance, even with a very short working distance (distance between the sensor lower end and the print surface), it becomes possible to pick up an image in a predetermined region of the print surface in its entirety. As a result, it becomes possible to produce a highly miniaturized sensor unit and print state inspection apparatus.

The illumination portion 20 is ordinarily provided in proximity to the opening 41 of the housing 40 in a direction parallel to the opening 41. The light-emission element 21 of the illumination portion 20 is preferably a high-intensity LED (typically, an ultra high-intensity white LED). The high-intensity LED has the following advantages: (1) its conversion efficiency from electricity to light is high, which enables energy saving; (2) it produces no heat, which is preferable also from the view point of environment; (3) its lifespan is long (around 100,000 hours that is 15 or more times as long as the average lifespan of fluorescent tubes that is around 6,000 hours), and even frequent turning on/off exerts no influence on the lifespan; (4) its lighting speed is extremely high; and (5) its size is small and its weight is light. The illuminance of the LED is preferably around 130 to 140 Lumens/W (which is around 1.8 times as high as that of the fluorescent tube). In the illumination portion 20, many LEDs are arranged regularly. Typically, the LEDs are arranged in a multi-line manner. More preferably, the LEDs are arranged at a relatively low density in their center portions and are arranged at a relatively high density in their both end portions. As compared with a high-frequency fluorescent tube conventionally used as the illumination means, the LEDs suffer from less light amount shortage on both sides and have markedly stable light amounts in both end portions, so that their lateral length can be reduced. In addition, by using the LEDs arranged regularly and the specific lens 22 (to be described later) in combination, it becomes possible to uniformly irradiate the whole of a predetermined region of the print surface, so it becomes possible to send a clear image to the image pickup portion.

The lens 22 of the illumination portion 20 has a shape with which it is possible to condense light irradiated from the light-emission element 21 on the print surface as appropriate. Typically, the lens 22 has an elliptic cylinder shape. By condensing light from the LEDs using such a lens, seam portions between adjacent LED elements can be made uniform, which makes it possible to irradiate the print with light having a line shape where no unevenness exists.

The first mirror 31 and the second mirror 32 of the reflecting portion 30 are arranged so that the reflected light from the print surface of the print W enters the image pickup portion 10 (that is, the image pickup element 11 through the lens 12) as appropriate. Typically, the first mirror 31 is arranged so that the first direction D1 described above has an angle of 90 degrees with respect to the direction of the normal to the print surface and the second mirror 32 is arranged so that the second direction D2 described above has an angle of 90 degrees with respect to the first direction D1. As a result, the reflected light enters the image pickup portion 10 in a direction parallel to the direction of the normal to the print surface. More specifically, the first mirror 31 is arranged so as to define an angle of 45 degrees with respect to the direction of the normal to the print surface and the second mirror 32 is arranged so as to define an angle of 45 degrees with respect to the first direction D1. The first mirror 31 and the second mirror 32 are preferably each an evaporated mirror. The evaporated mirror is high in reflection efficiency and is small in light amount reduction after reflection as compared with an ordinary optical mirror, so it becomes possible to provide the image pickup portion 10 with a bright image. In addition, the reflection surface of the mirror is a highly smooth plane and has a structure with which it is possible to maintain as much as possible the light amount of the reflected light entering the image pickup portion.

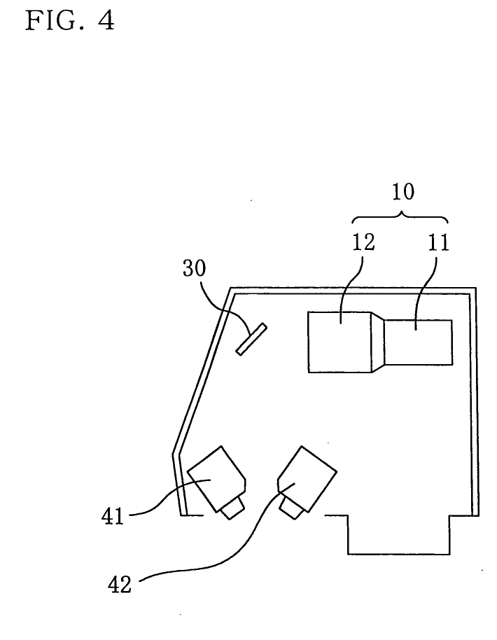

FIG. 4 is a schematic construction diagram of a sensor unit according to another preferred embodiment of the present invention. In this embodiment, a sensor unit 140 includes a first illumination portion 41 and a second illumination portion 42. The concrete constructions of the first and second illumination portions are the same as above. By providing the two illumination portions, it becomes possible to provide an image pickup portion 10 with a brighter and clearer image.

In addition, a reflecting portion 30 includes only one mirror that reflects reflected light from a print surface of a print W in a direction having a predetermined angle (90 degrees, in this embodiment) with respect to the direction of the normal to the print surface. Therefore, the image pickup portion 10 is fitted in a housing 40 so that the light-reception direction of an image pickup element 11 and a lens 12 becomes a 90-degree direction with respect to the direction of the normal to the print surface. According to this embodiment, reflection is performed only once, so reflected light entering the image pickup portion suffers less reduction in light amount.

With the sensor unit according to the present invention, it becomes possible to extremely reduce the size of the unit itself and it also becomes possible to extremely reduce the working distance (distance between the sensor lower end (in the vicinity of the illumination portion) and the print). As a matter of fact, the height of the block-shaped unit shown in FIGS. 1 to 3 is around 220 mm and the working distance thereof is around 35 to 40 mm. In the case of the conventional apparatus, the distance from the CCD camera to the print exceeds 1 m (1000 mm), so the present invention achieves miniaturization to ¼ or less.

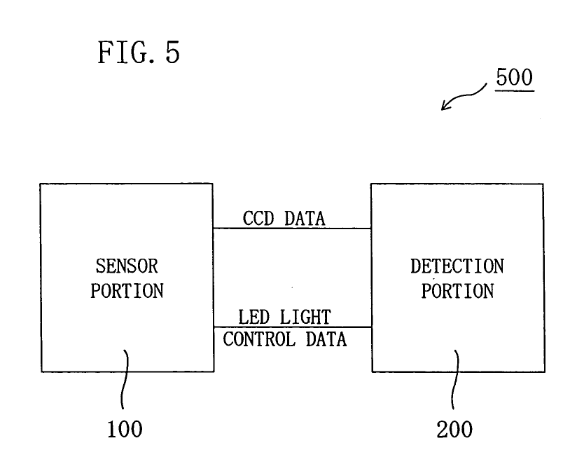

Next, a print state inspection apparatus according to a preferred embodiment of the present invention will be described. FIG. 5 is a block diagram showing a construction of the print state inspection apparatus. A print state inspection apparatus 500 includes a sensor portion 100 that irradiates a print surface of a print W arranged at a predetermined position with light and picks up an image formed by reflected light from the print surface, and a detection portion 200 that analyzes image data obtained by the sensor portion and detects a print defect. The sensor portion 100 is the sensor unit described above. As to the arrangement of the print W, in the case of a so-called off-line system, the print W extracted in accordance with inspection criteria is placed on a placement table and inspection is performed. On the other hand, in the case of an in-line system, the print state inspection apparatus can be incorporated into a print apparatus and the print on a transport belt or a transport drum is inspected.

The detection portion 200 may have an arbitrary appropriate construction in the print state inspection apparatus. In a typical operation at the detection portion 200, image data captured by the image pickup portion of the sensor portion 100 is position-corrected instantaneously and an inspection for a defect (such as foreign matter, a stain, print fading) and color monitoring (such as ΔE, YMCK separation) are performed at the same time.

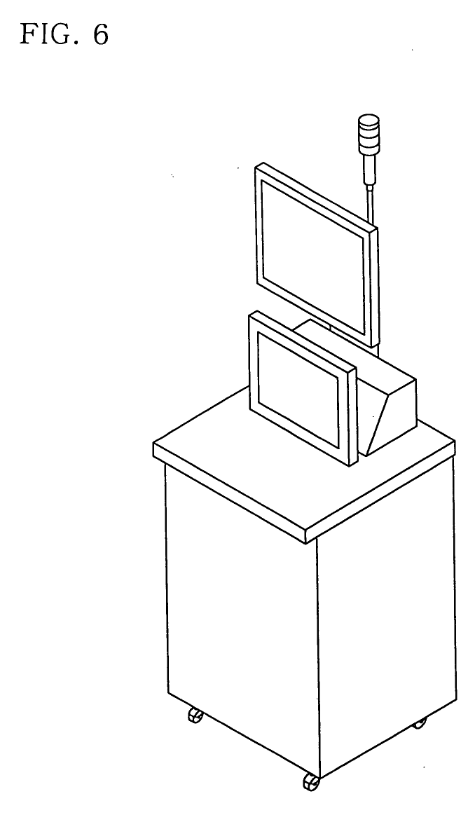

Preferably, the print state inspection apparatus according to the present invention further includes an operation stand shown in FIG. 6. The operation stand displays an image of an inspection target print on a screen in a real time manner, so visual inspection becomes extremely easy. A technique of displaying image data from the sensor portion on the operation stand is not a feature of the present invention and is also widely known, so the detailed description thereof will be omitted here.

The sensor unit and the print state inspection apparatus according to the present invention are highly accurate and are also very compact, so attachment to a print apparatus that has conventionally been difficult becomes possible. Accordingly, the sensor unit according to the present invention is suitably applicable to a wide variety of print apparatuses.

Many other modifications will be apparent to and be readily practiced by those skilled in the art without departing from the scope and spirit of the invention. It should therefore be understood that the scope of the appended claims is not intended to be limited by the details of the description but should rather be broadly construed.

1. A sensor unit that irradiates a print surface with light and picks up an image formed by reflected light from the print surface,
the sensor unit comprising:
an image pickup portion including an image pickup element and a lens fitted to the image pickup element;
an illumination portion including a light-emission element and a lens fitted to the light-emission element; and
a reflecting portion including at least one mirror that reflects the reflected light from the print surface in a direction having a predetermined angle with respect to a direction of normal to the print surface.

2. A sensor unit according to claim 1, wherein the reflecting portion includes:
a first mirror that reflects the reflected light from the print surface in a first direction having a predetermined angle with respect to the direction of the normal to the print surface; and
a second mirror that reflects the light reflected in the first direction in a second direction having a predetermined angle with respect to the first direction.

3. A sensor unit according to claim 2, wherein the first direction has an angle of 90 degrees with respect to the direction of the normal to the print surface, and wherein the second direction has an angle of 90 degrees with respect to the first direction.

4. A sensor unit according to claim 1, wherein the image pickup element is a CCD camera, and wherein the light-emission element is a high-intensity LED.

5. A sensor unit according to claim 2, wherein the first mirror and the second mirror are each an evaporated mirror.

6. A print state inspection apparatus that irradiates a print surface of a print arranged at a predetermined position with light, picks up an image formed by reflected light from the print surface, and detects a print defect with reference to an obtained image,
the print state inspection apparatus comprising:
a sensor portion that irradiates the print surface with the light and picks up the image formed by the reflected light from the print surface; and
a detection portion that detects the print defect by analyzing image data obtained by the sensor portion,
wherein the sensor portion includes:
an image pickup portion including an image pickup element and a lens fitted to the image pickup element;
an illumination portion including a light-emission element and a lens fitted to the light-emission element; and
a reflecting portion including at least one mirror that reflects the reflected light from the print surface in a direction having a predetermined angle with respect to a direction of normal to the print surface.
